(19) United States
(12) Patent Application Publication
(10) Pub. No.: US 2011/0314157 A1
(43) Pub. Date: Dec. 22, 2011

(54) INFORMATION PROCESSING SYSTEM, MANAGEMENT APPARATUS, PROCESSING REQUESTING APPARATUS, INFORMATION PROCESSING METHOD, AND COMPUTER READABLE MEDIUM STORING PROGRAM

(75) Inventor: Shinichi SAITO, Kanagawa (JP)

(73) Assignee: FUJI XEROX CO., LTD., Tokyo (JP)

(21) Appl. No.: 12/917,164

(22) Filed: Nov. 1, 2010

(30) Foreign Application Priority Data
Jun. 16, 2010 (JP) 2010-137300

(51) Int. Cl. G06F 15/173

(52) U.S. Cl. 709/226

(57) ABSTRACT

An information processing system includes a receiving unit that receives a request for assigning computer resources for processing data and identification information that identifies data processing to be performed on the data, an assigning unit that assigns at least part of computer resources included in one of one or plural computers in response to the request, a specifying unit that specifies storage location information showing a storage location of the data in the assigned computer resources on the basis of the computer resources, a transfer unit that transfers the data to be processed to the storage location, and a deploying unit that deploys one or plural programs constituting the data processing to the assigned computer resources so that the one or plural programs are executed using the assigned computer resources.

### CROSS-REFERENCE TO RELATED APPLICATIONS

This application is based on and claims priority under 35 USC 119 from Japanese Patent Application No. 2010-137300 filed Jun. 16, 2010.

### BACKGROUND

### (i) Technical Field

The present invention relates to an information processing system, a management apparatus, a processing requesting apparatus, an information processing method, and a computer readable medium storing a program.

### SUMMARY

According to an aspect of the invention, there is provided an information processing system including a receiving unit that receives a request for assigning computer resources for processing data and identification information that identifies data processing to be performed on the data, an assigning unit that assigns at least part of computer resources included in one of one or plural computers in response to the request received by the receiving unit, a specifying unit that specifies storage location information showing a storage location of the data in the computer resources assigned by the assigning unit on the basis of the computer resources assigned by the assigning unit, a transfer unit that transfers the data to be processed by the computer resources assigned by the assigning unit to the storage location shown by the storage location information specified by the specifying unit, and a deploying unit that deploys, after the data to be processed has been transferred to the storage location by the transfer unit, one or plural programs constituting the data processing identified by the identification information received by the receiving unit to the computer resources assigned by the assigning unit so that the one or plural programs are executed using the computer resources assigned by the assigning unit.

### BRIEF DESCRIPTION OF THE DRAWINGS

Exemplary embodiments of the present invention will be described in detail based on the following figures, wherein:

FIG. 1 is a system configuration diagram of an information processing system;

FIG. 2 is a functional block diagram of individual apparatuses included in the information processing system;

FIG. 3 is a diagram illustrating an example of a virtual machine status management table;

FIG. 4 is a diagram illustrating an example of an updated virtual machine status management table;

FIG. 5 is a diagram illustrating an example of a service definition table;

FIG. 6 is a diagram illustrating an example of an updated virtual machine status management table;

FIG. 7 is a sequence diagram of a process performed by the information processing system and a virtual machine;

FIG. 8 is a diagram illustrating an example of a virtual machine status management table;

FIG. 9 is a diagram illustrating an example of execution wait queues;

FIG. 10 is a diagram illustrating an example of a service definition table; and

FIG. 11 is a sequence diagram of a process performed by the information processing system and a virtual machine.

### DETAILED DESCRIPTION

Hereinafter, exemplary embodiments of the invention will be described with reference to the drawings. First, a first exemplary embodiment of the invention will be described.

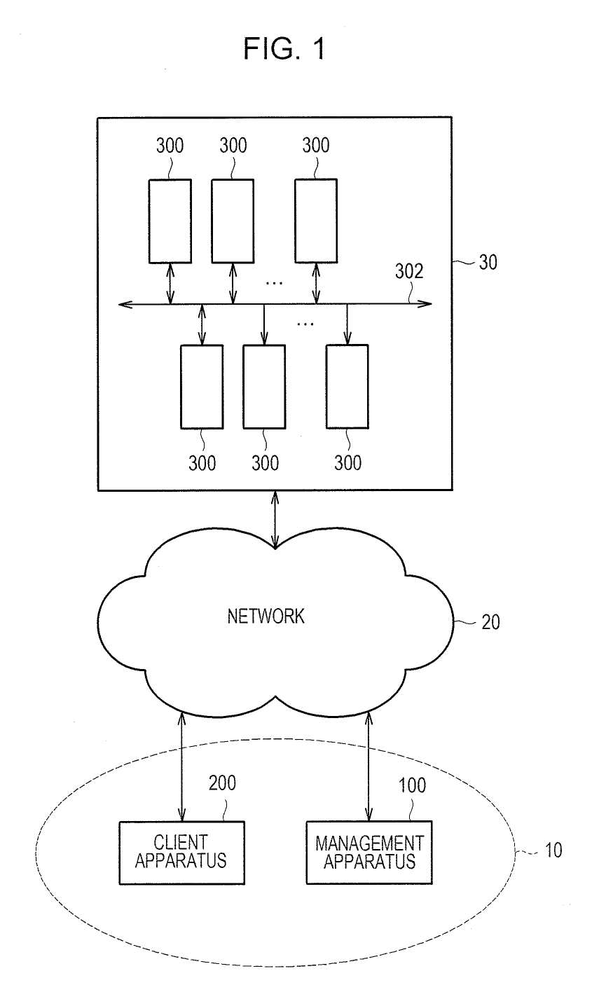

FIG. 1 illustrates a system configuration diagram of an information processing system 10 according to this exemplary embodiment. As illustrated in FIG. 1, the information processing system 10 includes a client apparatus 200 that requests the use of at least part of the computer resources of a computer group 30 including one or plural computers 300, and also includes a management apparatus 100 that receives the request for use from the client apparatus 200 and that performs various types of control processing, such as assignment of computer resources. In this exemplary embodiment, the individual computers 300 included in the computer group 30, the management apparatus 100, and the client apparatus 200 perform data communication with each other via a network 20, such as the Internet, but the form of connection among these apparatuses is not limited to the foregoing form as long as these apparatuses can perform data communication with each other.

The computer group 30 includes one or plural computers 300, and the individual computers 300 are connected so that they can perform data communication with each other via a network 302. Each of the computers 300 included in the computer group 30 is provided with computer resources (hardware resources) including one or plural processors, a memory, and a magnetic disk device. The computer resources provided in the computer group 30 may be divided into one or plural segments and may be formed as logical computers called virtual machines. Alternatively, a virtual machine may be formed by dividing the usage time of all or part of hardware and by assigning at least part thereof.

The management apparatus 100 is a computer that receives a request for using the computer group 30 from the client apparatus 200, assigns a virtual machine to the client apparatus 200, and performs control for causing the assigned virtual machine to execute the data processing requested by the client apparatus 200. The details of the functions provided in the management apparatus 100 will be described below.

The client apparatus 200 is a computer that receives an input from a user, requests the assignment of a virtual machine from the computer group 30 in response to the input from the user, and also requests the execution of data processing using the virtual machine that is assigned in response to the request. The details of the functions provided in the client apparatus 200 will be described below.

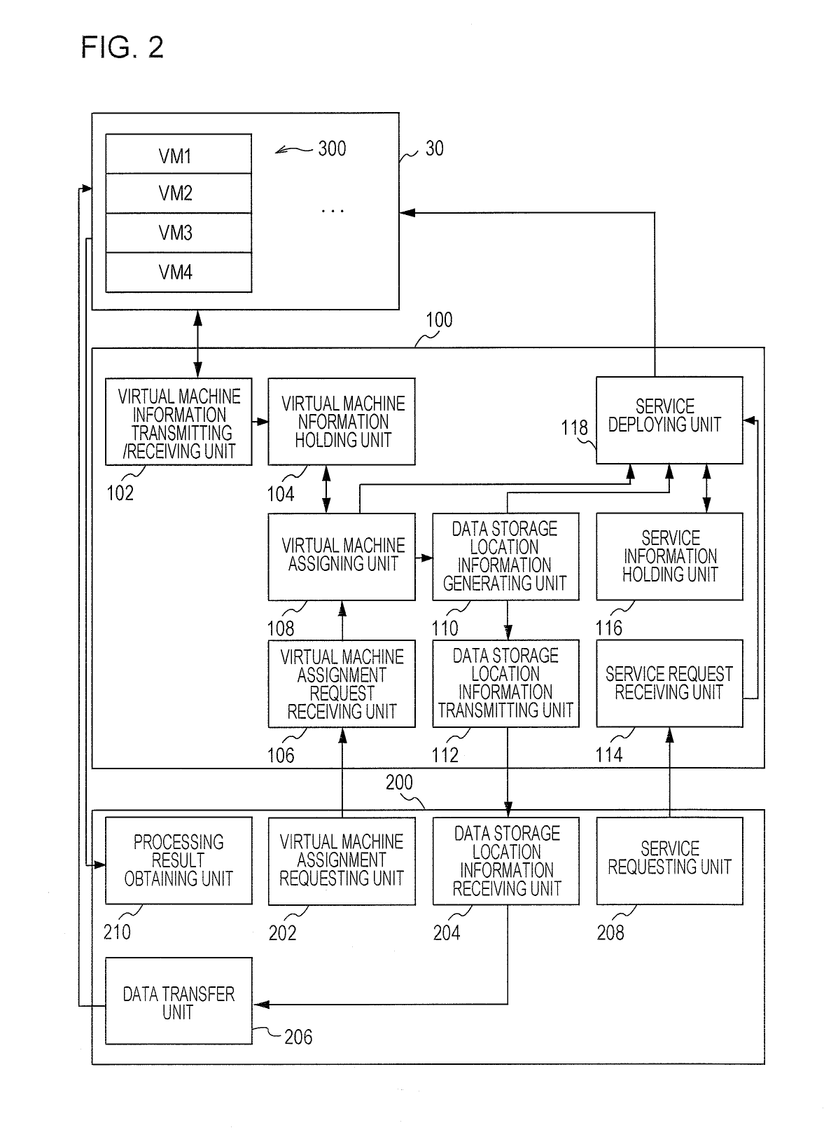

FIG. 2 illustrates a functional block diagram of the individual apparatuses included in the information processing system 10. Hereinafter, the details of the functions provided in the management apparatus 100 and the client apparatus 200 included in the information processing system 10 will be described with reference to the functional block diagram illustrated in FIG. 2.

The computer resources included in the computer group 30 are divided into plural segments, so that plural virtual machines are formed. In the example illustrated in FIG. 2, VM1 to VM4 denote virtual machines that are formed by dividing the computer resources of the computer 300 into four segments. In this exemplary embodiment, virtual machines may be formed in advance. The formed virtual machines include at least one virtual machine that is formed by dividing one computer 300 into one or plural segments.

As illustrated in FIG. 2, the management apparatus 100 includes a virtual machine information transmitting/receiving unit 102, a virtual machine information holding unit 104, a virtual machine assignment request receiving unit 106, a virtual machine assigning unit 108, a data storage location information generating unit 110, a data storage location information transmitting unit 112, a service request receiving unit 114, a service information holding unit 116, and a service deploying unit 118. The functions of these units may be realized when a computer, which includes a control unit such as a central processing unit (CPU), a storage unit such as a memory or a magnetic disk device, and a communication unit that transmits data to/receives data from an external device, reads and executes a program stored in a computer-readable information storage medium. The program may be supplied to the computer functioning as the management apparatus 100 via an information storage medium, or may be supplied to the computer via a data communication medium such as the Internet.

The virtual machine information transmitting/receiving unit 102 transmits/receives information about virtual machines formed in the computer group 30 to/from a management computer that is included in the computer group 30 and that manages information about the virtual machines. The information about virtual machines may be periodically transmitted/received between the management apparatus 100 and the computer group 30, or may be transmitted/received when the information is changed. For example, the information about virtual machines may include status information showing the statuses of the virtual machines and resource information showing the hardware resources constituting the virtual machines. For example, the status information may include identification information of the client apparatus 200 to which a virtual machine is assigned (client name or the like) and the name of a service that is being executed (data processing name or the like), which correspond to individual virtual machines. The resource information may include information showing the hardware of the computer 300 in the computer group 30 constituting each virtual machine.

The virtual machine information holding unit 104 holds information about virtual machines received by the virtual machine information transmitting/receiving unit 102.

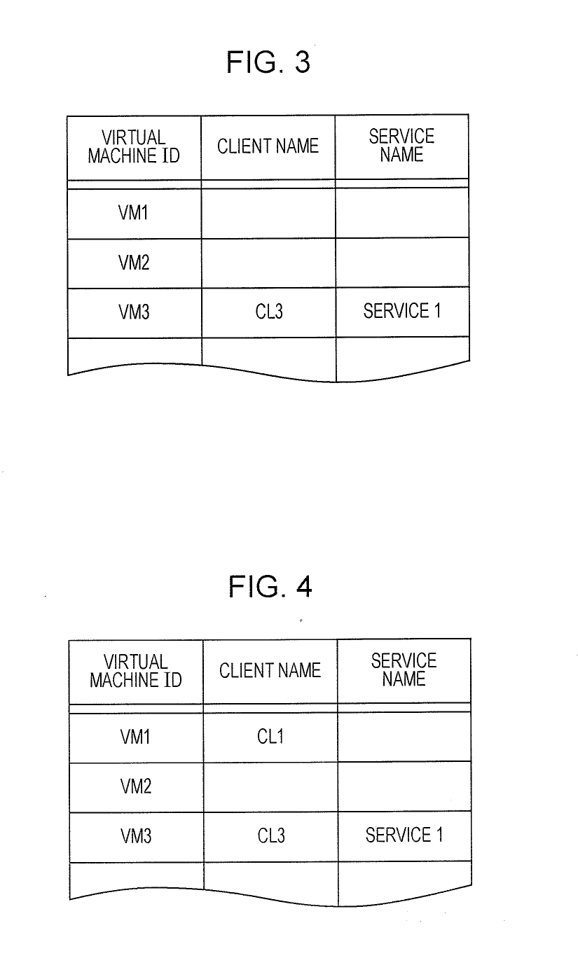

FIG. 3 illustrates an example of a virtual machine status management table (status information) that is held in the virtual machine information holding unit 104. As illustrated in FIG. 3, the virtual machine status management table stores client names that identify the client apparatuses 200 to which virtual machines are assigned and service names representing the data processing operations that are being executed in the virtual machines, the client names and service names being associated with virtual machine IDs that identify the virtual machines. If a field of the client name is blank in the virtual machine status management table, it means that the corresponding virtual machine is not assigned to any client apparatus 200 (that is, the virtual machine is vacant).

The virtual machine assignment request receiving unit 106 receives a request for assigning a virtual machine from the client apparatus 200. The request for assigning a virtual machine may include the client name that identifies the client apparatus 200 and information showing the computer resources requested by the client apparatus 200 (e.g., the number of processors, the capacity of a memory, and the capacity of a disk).

The virtual machine assigning unit 108 assigns a virtual machine to the client apparatus 200 in response to the request received by the virtual machine assignment request receiving unit 106. For example, the virtual machine assigning unit 108 may refer to the virtual machine status management table held in the virtual machine information holding unit 104, select a virtual machine corresponding to a blank field of the client name in the table, and assign the selected virtual machine to the client apparatus 200. At this time, the virtual machine assigning unit 108 may search for virtual machines that are constituted by computer resources of a single computer and select a virtual machine from among them. If the request from the client apparatus 200 includes information showing computer resources, a virtual machine that satisfies the computer resources may be selected. If no vacant virtual machine exists (if no virtual machine satisfies a specified condition), the virtual machine assigning unit 108 may perform control to transmit information showing that there is no virtual machine to be assigned to the client apparatus 200.

FIG. 4 illustrates an example of a virtual machine status management table that has been updated after a virtual machine has been assigned by the virtual machine assigning unit 108. As illustrated in FIG. 4, when a virtual machine “VM1” has been assigned to a client “CL1”, “CL1” is stored in the field of the client name associated with “VM1” in the virtual machine status management table.

The data storage location information generating unit 110 generates (specifies) storage location information showing the storage location of data that is to be processed by a virtual machine on the basis of the information about the virtual machine assigned by the virtual machine assigning unit 108. For example, the data storage location information generating unit 110 may generate, as storage location information, the name of a file that is stored in a storage (data storage device) included in the virtual machine assigned by the virtual machine assigning unit 108. The storage location information may be generated on the basis of any generation rule as long as data is uniquely identified in the virtual machine. In this exemplary embodiment, the data storage location information generating unit 110 may generate, as storage location information, a path (/VM1/S1/File1) composed of the name of the virtual machine (VM1), the name of the storage (S1) of the virtual machine, and the name of the file (File1) stored in the storage.

The data storage location information transmitting unit 112 transmits the storage location information generated by the data storage location information generating unit 110 to the client apparatus 200 that has transmitted the request for assigning a virtual machine.

The service request receiving unit 114 receives, from the client apparatus 200, a request for executing data processing (service) in the virtual machine assigned to the client apparatus 200. For example, the service request receiving unit 114 may receive, from the client apparatus 200, the client name and service identification information (service name or the like) that identifies the data processing to be executed.

The service information holding unit 116 holds information about data processing operations that constitute services each of which is identified by service identification information. The service information holding unit 116 may further hold substance data of programs that constitute the individual data processing operations.

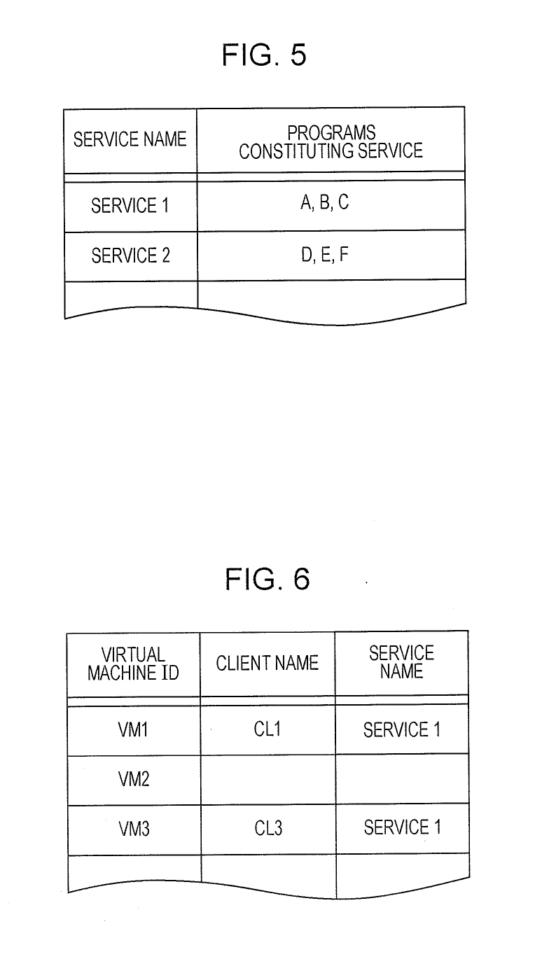

FIG. 5 illustrates an example of a service definition table that is held in the service information holding unit 116. As illustrated in FIG. 5, the service definition table is configured to store programs constituting services that indicate information about the programs (data processing element, primitive service) which constitute the individual services, the programs being associated with service names. If “A, B, C” is stored as the information about the programs constituting a service, it means that processes A, B, and C are executed in this order.

The service deploying unit 118 obtains the programs that constitute a service requested in a request received by the service request receiving unit 114 by referring to the service information holding unit 116, and deploys the obtained programs to the virtual machine assigned by the virtual machine assigning unit 108. For example, the service deploying unit 118 generates deploy information including information about the programs that constitute the service, the execution order of the programs, and the storage location of data to be processed, and transfers the generated deploy information to the virtual machine, thereby deploying the service. Also, on the basis of the programs deployed to the virtual machine by the service deploying unit 118, the virtual machine executes processing on the data stored in the storage location indicated by the information generated by the data storage location information generating unit 110.

FIG. 6 illustrates an example of the virtual machine status management table that has been updated in a case where a service (programs) is deployed by the service deploying unit 118. As illustrated in FIG. 6, after programs have been deployed to the virtual machine by the service deploying unit 118 or after the programs to be deployed have been specified, information showing the deployed service is stored in the field of the service name corresponding to the assigned virtual machine.

After the programs have been deployed by the service deploying unit 118, the virtual machine executes the deployed programs in the specified execution order on the data to be processed transferred from the client apparatus 200. The virtual machine transmits processing result data, which is obtained thorough the processing, to the client apparatus 200, and notifies the management apparatus 100 that the execution of the programs deployed by the service deploying unit 118 has been completed. When receiving the notification showing that the execution of the programs has been completed from the virtual machine, the management apparatus 100 updates the record of the virtual machine stored in the virtual machine status management table. Specifically, the management apparatus 100 may erase the data of the client name and service name that are associated with the virtual machine, so as to update the virtual machine status management table. Also, after completing the execution of the deployed programs, the virtual machine may delete the deployed programs and the data transferred from the client apparatus 200. At this time, the virtual machine may delete the data in response to a request from the client apparatus 200, or may delete the data after a certain time has elapsed since the end of the processing.

Next, the functions provided in the client apparatus 200 will be described. As illustrated in FIG. 2, the client apparatus 200 includes a virtual machine assignment requesting unit 202, a data storage location information receiving unit 204, a data transfer unit 206, a service requesting unit 208, and a processing result obtaining unit 210. The functions of these units may be realized when a computer, which includes a control unit such as a CPU, a storage unit such as a memory, and a communication unit that transmits data to/receives data from an external device, reads and executes a program stored in a computer-readable information storage medium. The program may be supplied to the computer functioning as the client apparatus 200 via an information storage medium, or may be supplied to the computer via a data communication medium such as the Internet.

The virtual machine assignment requesting unit 202 requests, to the management apparatus 100, the assignment of a virtual machine from the computer group 30. At the time of requesting the assignment of a virtual machine, the virtual machine assignment requesting unit 202 may transmit information showing necessary computer resources together with the client name that identifies the client apparatus 200 to the management apparatus 100.

When a virtual machine is assigned in response to the request for assignment transmitted by the virtual machine assignment requesting unit 202, the data storage location information receiving unit 204 receives, from the management apparatus 100, storage location information showing the storage location of the data that is to be processed by the assigned virtual machine. In this exemplary embodiment, the data storage location information receiving unit 204 receives storage location information that is transmitted from the data storage location information transmitting unit 112 of the management apparatus 100.

The data transfer unit 206 transfers data to be processed to the storage location indicated by the storage location information received by the data storage location information receiving unit 204. The data transfer unit 206 may change the file name of the data to be processed to the file name indicated by the storage location information and then transfer the data by accessing the virtual machine. At this time, the path of the storage location of the data to be processed may be determined on the basis of the path indicated by the storage location information.

The service requesting unit 208 transmits, to the management apparatus 100, information that identifies a service (data processing) for processing the data transferred by the data transfer unit 206, thereby requesting the execution of the service on the data. In this exemplary embodiment, the service request transmitted by the service requesting unit 208 to the management apparatus 100 is received by the service request receiving unit 114 of the management apparatus 100.

If a specified service (data processing) has been executed on the data transferred by the data transfer unit 206, the processing result obtaining unit 210 obtains a processing result of the service. The processing result obtaining unit 210 may receive and obtain a processing result transmitted from the virtual machine.

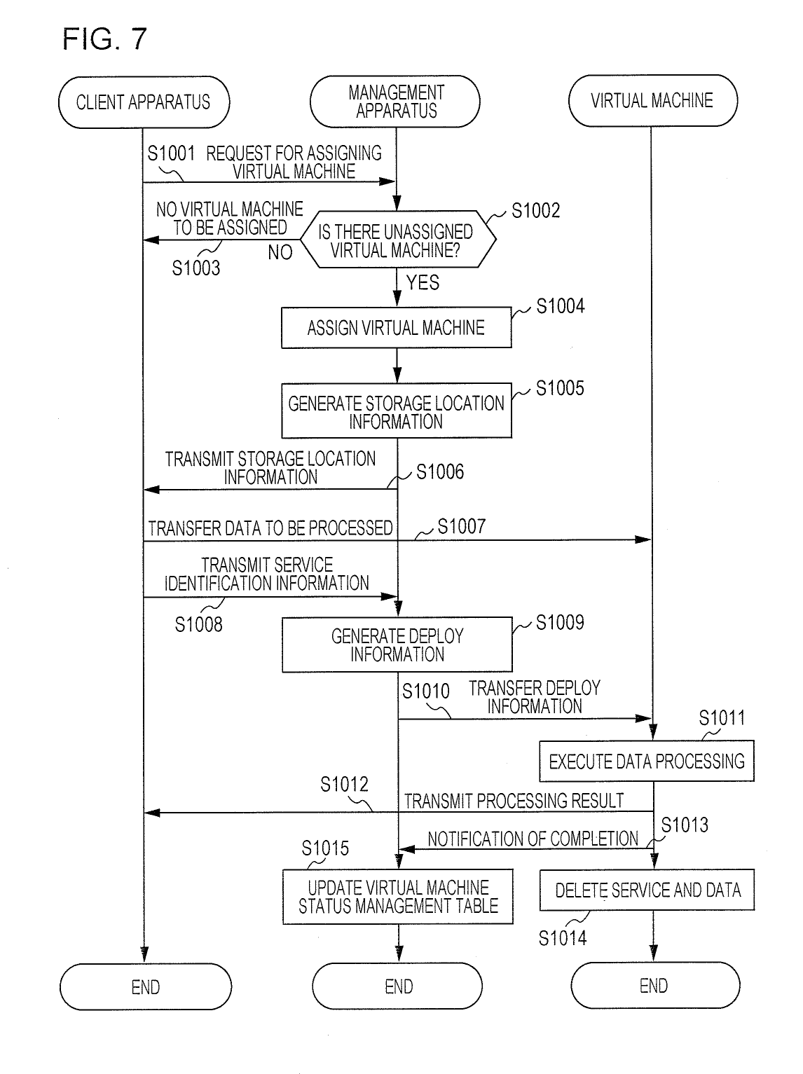

Next, a description will be given of the flow of a process performed by the information processing system 10 and a virtual machine assigned to the client apparatus 200 according to this exemplary embodiment with reference to the sequence diagram illustrated in FIG. 7.

First, the client apparatus 200 transmits a request for assigning a virtual machine to the management apparatus 100 (S1001). In response to the request received from the client apparatus 200, the management apparatus 100 determines whether there is an unassigned virtual machine or not by referring to the virtual machine status management table (S1002). If there is no unassigned virtual machine (NO in S1002), the management apparatus 100 transmits information showing that there is no virtual machine to be assigned (S1003). If there is an unassigned virtual machine (YES in S1002), the management apparatus 100 assigns a virtual machine to the client apparatus 200 (S1004). Then, the management apparatus 100 generates storage location information showing the storage location of data in the assigned virtual machine (S1005) and transmits the generated storage location information to the client apparatus 200 (S1006).

The client apparatus 200 transfers the data to be processed to the storage location in the virtual machine indicated by the storage location information received from the management apparatus 100 (S1007) and also transmits service identification information that identifies a service (data processing) for processing the data to the management apparatus 100 (S1008). On the basis of the service identification information received from the client apparatus 200, the management apparatus 100 specifies the programs constituting the service, generates deploy information based on the individual specified programs, the execution order of the programs, and the target of the execution (S1009), and transfers the generated deploy information to the virtual machine (S1010).

The virtual machine deploys the programs on the basis of the deploy information received from the management apparatus 100, executes the data processing on the data (S1011), and then transmits a processing result to the client apparatus 200 (S1012). Then, the virtual machine transmits a service completion notification to the management apparatus 100 (S1013) and deletes the deployed service and the data (S1014). When receiving the service completion notification from the virtual machine, the management apparatus 100 specifies the record related to the virtual machine in the virtual machine status management table, and deletes the client name and service name in the specified record, so as to update the table (S1015). Accordingly, a series of operations related to the data processing requested by the client apparatus 200 ends.

In the information processing system 10 according to this exemplary embodiment, data to be processed is stored in a storage included in the hardware resources of the virtual machine assigned to the client apparatus 200, and the virtual machine is caused to process the data. Accordingly, a processing delay caused by transfer of data to be processed does not occur.

Next, a second exemplary embodiment of the invention will be described. The information processing system 10 according to the second exemplary embodiment is different from the information processing system 10 according to the first exemplary embodiment in that execution wait queues are held for respective virtual machines and that a virtual machine to be assigned to the client apparatus 200 is selected on the basis of the amount of data related to the data processing that is to be executed by the virtual machine. The processing performed after a virtual machine has been assigned is common. Hereinafter, the difference from the information processing system 10 according to the first exemplary embodiment will be described.

The virtual machine information holding unit 104 according to the second exemplary embodiment holds a virtual machine status management table showing the statuses of the individual virtual machines and execution wait queues storing processing information showing the processing that is assigned to the respective virtual machines and that is in an execution standby state.

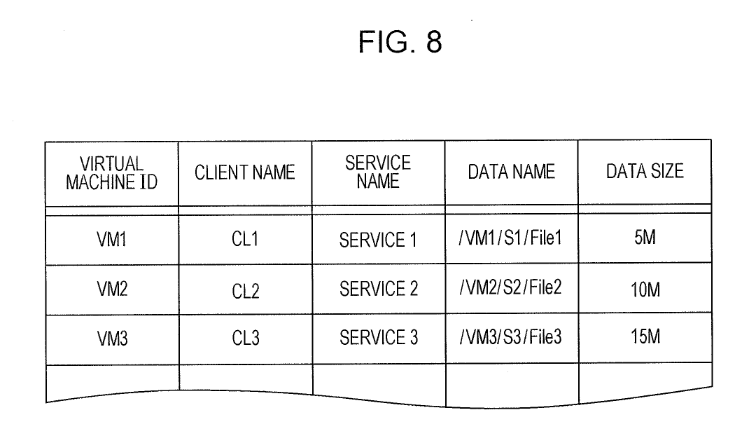

FIG. 8 illustrates an example of the virtual machine status management table. As illustrated in FIG. 8, the virtual machine information management table stores client names representing the client apparatuses 200 to which virtual machines are assigned, service names representing the services that are being executed, the names of pieces of data processed by the services that are being executed, and the sizes of the respective pieces of data, which are associated with the identification information of the virtual machines (virtual machine IDs).

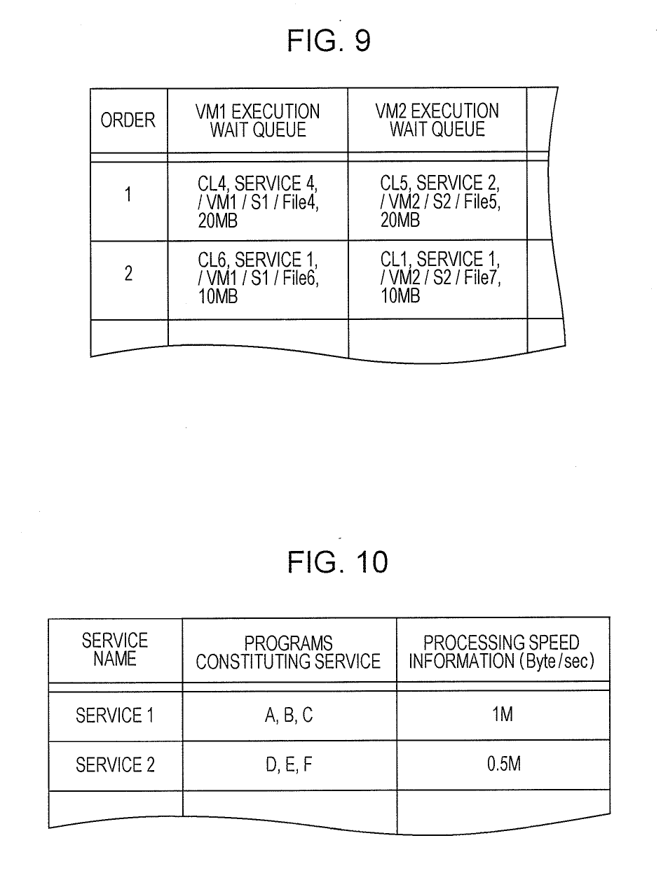

FIG. 9 illustrates an example of the execution wait queues. The execution wait queues are provided for the respective virtual machines, and the processing information showing the processing assigned by the virtual machine assigning unit 108 is stored in assignment order in the last portion of the respective execution wait queues. For example, the processing information may be information corresponding to a record of the virtual machine information management table and include the items of a client name, a service name, a data name, and a data size.

The virtual machine assignment request receiving unit 106 receives a request for assigning a virtual machine from the client apparatus 200. The request includes pieces of information such as the client name that identifies the client apparatus 200, the name of a service that is requested to be executed, and the size of data to be processed.

When receiving the request for assigning a virtual machine from the client apparatus 200, the virtual machine assigning unit 108 refers to the virtual machine status management table and the execution wait queues held in the virtual machine information holding unit 104, and calculates, for the individual virtual machines, the total size of data processed by the service that is currently being executed and the service that is to be executed. Then, the virtual machine assigning unit 108 assigns the virtual machine in which the calculated total size is the smallest to the client apparatus 200. After the virtual machine has been assigned by the virtual machine assigning unit 108, the processing information included in the request received from the client apparatus 200 is added to the execution wait queue of the assigned virtual machine. After the virtual machine has been assigned to the client apparatus 200, processing similar to that in the first exemplary embodiment is executed. However, the processing is different from that in the first exemplary embodiment in that the service deploying unit 118 deploys the service to be executed next by referring to the execution wait queue. Hereinafter, this point will be described.

When receiving a processing completion notification from the virtual machine, the service deploying unit 118 obtains the processing information at the top in the execution wait queue by referring to the execution wait queue of the virtual machine. The service deploying unit 118 generates deploy information on the basis of the obtained processing information and transfers the generated deploy information to the virtual machine. After completing the deploy of a service, the service deploying unit 118 updates the items in the virtual machine status management table (client name, service name, data name, data size, etc.) corresponding to the virtual machine to which the service has been deployed, and also deletes the processing information about the executed processing in the execution wait queue and moves forward the processing order of the other processing information by one, thereby performing update.

In the information processing system 10 according to the second exemplary embodiment, even if no vacant virtual machine exists, a virtual machine in which the amount of processed data is small is assigned to the client apparatus 200 in response to a service request from the client apparatus 200, so that the time until a service is provided to the client apparatus 200 is shortened.

Next, a third exemplary embodiment of the invention will be described. The information processing system 10 according to the third exemplary embodiment is different from the information processing system 10 according to the second exemplary embodiment in that a virtual machine to be assigned to the client apparatus 200 is selected on the basis of the time for data processing that is to be executed by the virtual machine, but the other points are common. Hereinafter, the difference from the information processing system 10 according to the second exemplary embodiment will be described.

The service information holding unit 116 according to the third exemplary embodiment holds processing speed information per unit data for respective services executed in virtual machines.

FIG. 10 illustrates an example of a service definition table held in the service information holding unit 116. As illustrated in FIG. 10, the service definition table stores programs constituting services that indicate information about the programs (data processing elements) which constitute the individual services, and processing speed information, showing a processing speed per unit data, which are associated with identification information that identify services (service names). The processing speed information shows the amount of data that is processed by a virtual machine of a basic configuration (per unit) per second. In the example illustrated in FIG. 10, a virtual machine processes one Mb of data per second in service 1. The processing speed information may be held by measuring the processing time in advance.

The virtual machine information holding unit 104 may hold information about the processing performances of the individual virtual machines, for example, may hold the ratio of the processing speed with respect to that of the virtual machine of the basic configuration as performance information.

When receiving a request for assigning a virtual machine from the client apparatus 200, the virtual machine assigning unit 108 refers to the virtual machine status management table and the execution wait queues held in the virtual machine information holding unit 104, and calculates, for the individual virtual machines, the total processing time for completing the service that is currently being executed and the service that is to be executed. Specifically, the virtual machine assigning unit 108 may calculate a processing time by dividing the data size included in the processing information by a virtual machine processing speed, which is obtained by multiplying the processing speed associated with the service by the performance information of the virtual machine. Then, the virtual machine assigning unit 108 sums up the processing times calculated for the individual virtual machines, and assigns the virtual machine in which the total processing time is the shortest to the client apparatus 200. After the virtual machine has been assigned by the virtual machine assigning unit 108, the processing information included in the request received from the client apparatus 200 is added to the execution wait queue of the assigned virtual machine. The processing performed after the virtual machine has been assigned to the client apparatus 200 is the same as that in the second exemplary embodiment, and thus the description thereof is omitted.

In the information processing system 10 according to the third exemplary embodiment, even if no vacant virtual machine exists, a virtual machine in which the processing time for completing an assigned service is the shortest is assigned to the client apparatus 200 in response to a service request from the client apparatus 200, so that the time until a service is provided to the client apparatus 200 is shortened.

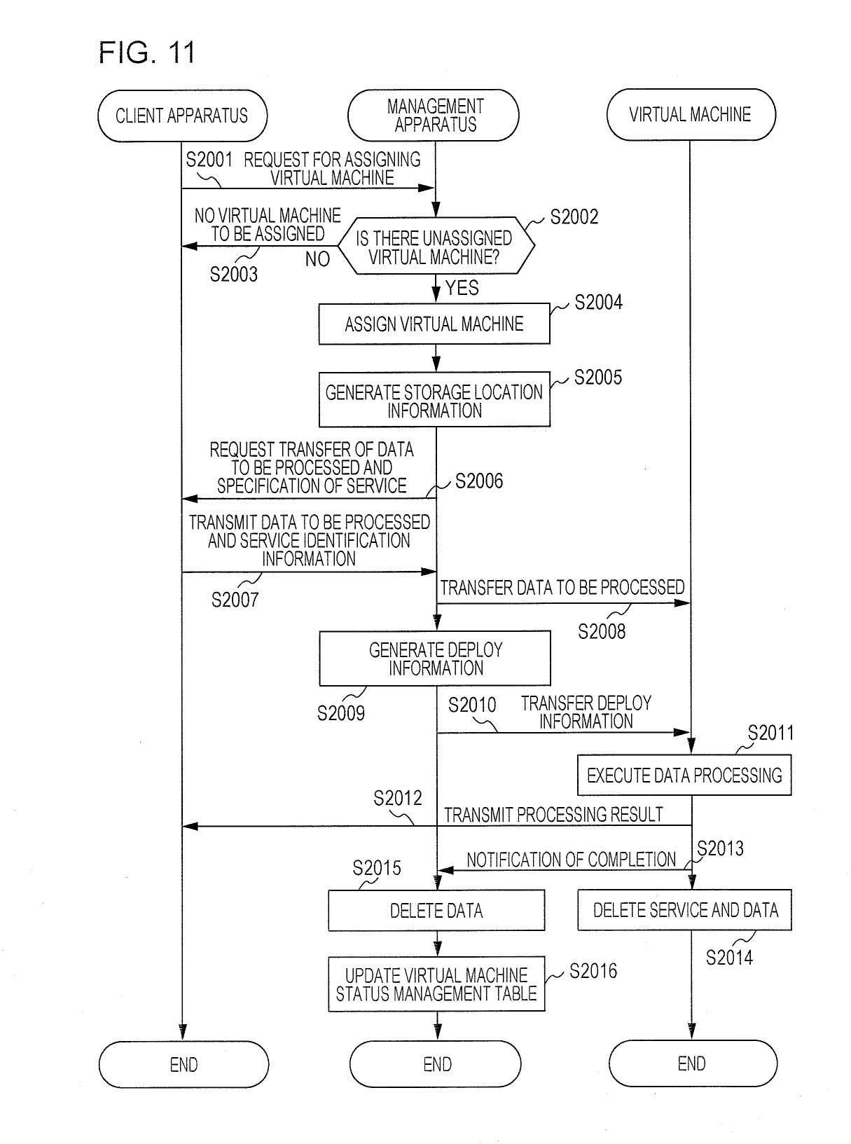

Next, a fourth exemplary embodiment of the invention will be described. The information processing system 10 according to the fourth exemplary embodiment is different from the information processing system 10 according to the first exemplary embodiment in that the management apparatus 100 transfers data to be processed to a virtual machine, and the other points are common. Hereinafter, the flow of a process in the information processing system 10 according to the fourth exemplary embodiment will be described with reference to the sequence diagram illustrated in FIG. 11.

First, the client apparatus 200 transmits a request for assigning a virtual machine to the management apparatus 100 (S2001). In response to the request received from the client apparatus 200, the management apparatus 100 determines whether there is an unassigned virtual machine or not by referring to the virtual machine status management table (S2002). If there is no unassigned virtual machine (NO in S2002), the management apparatus 100 transmits information showing that there is no virtual machine to be assigned to the client apparatus 200 (S2003). If there is an unassigned virtual machine (YES in S2002), the management apparatus 100 assigns a virtual machine to the client apparatus 200 (S2004). Then, the management apparatus 100 generates storage location information showing the storage location of data in the assigned virtual machine (S2005) and requests the client apparatus 200 to transfer the data to be processed and to specify a service (S2006).

The client apparatus 200 transmits the data to be processed and service identification information that identifies the service for processing the data (data processing) to the management apparatus 100 (S2007). The management apparatus 100 transfers the data to be processed received from the client apparatus 200 to the virtual machine on the basis of the generated storage location information (S2008). Then, the management apparatus 100 specifies the programs constituting the service on the basis of the service identification information received from the client apparatus 200, generates deploy information based on the specified programs, the execution order of the programs, and the target of execution (S2009), and transfers the generated deploy information to the virtual machine (S2010).

The virtual machine executes data processing on the data on the basis of the deploy information received from the management apparatus 100 (S2011). The virtual machine transmits a processing result of the data processing to the client apparatus 200 (S2012), transmits a service completion notification to the management apparatus 100 (S2013), and then deletes the deployed service and the data (S2014). When receiving the service completion notification from the virtual machine, the management apparatus 100 deletes the data (S2015), specifies the record related to the virtual machine in the virtual machine status management table, and deletes the client name and service name in the specified record to update the virtual machine status management table (S2016). Accordingly, a series of operations related to the data processing requested by the client apparatus 200 ends.

In the fourth exemplary embodiment, the data to be processed may be transmitted to the management apparatus 100 when requesting the assignment of a virtual machine. Also, the assignment of a virtual machine may be performed in the manner according to the second or third exemplary embodiment.

The present invention is not limited to the above-described exemplary embodiments. For example, the management apparatus 100 may be formed as one of the computers 300 included in the computer group 30.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a receiving unit that receives a request for assigning computer resources for processing data and identification information that identifies data processing to be performed on the data;
an assigning unit that assigns at least part of computer resources included in one of one or a plurality of computers in response to the request received by the receiving unit;
a specifying unit that specifies storage location information showing a storage location of the data in the computer resources assigned by the assigning unit on the basis of the computer resources assigned by the assigning unit;
a transfer unit that transfers the data to be processed by the computer resources assigned by the assigning unit to the storage location shown by the storage location information specified by the specifying unit; and
a deploying unit that deploys, after the data to be processed has been transferred to the storage location by the transfer unit, one or a plurality of programs constituting the data processing identified by the identification information received by the receiving unit to the computer resources assigned by the assigning unit so that the one or the plurality of programs are executed using the computer resources assigned by the assigning unit.

2. A management apparatus comprising:
a receiving unit that receives a request for assigning computer resources for processing data and identification information that identifies data processing to be performed on the data;
an assigning unit that assigns at least part of computer resources included in one of one or a plurality of computers in response to the request received by the receiving unit;
a specifying unit that specifies storage location information showing a storage location of the data in the computer resources assigned by the assigning unit on the basis of the computer resources assigned by the assigning unit;
a unit that causes the data to be processed by the computer resources assigned by the assigning unit to be transferred to the storage location shown by the storage location information specified by the specifying unit; and
a deploying unit that deploys, after the data to be processed has been transferred to the storage location, one or a plurality of programs constituting the data processing identified by the identification information received by the receiving unit to the computer resources assigned by the assigning unit so that the one or the plurality of programs are executed using the computer resources assigned by the assigning unit.

3. A processing requesting apparatus comprising:
an assignment request transmitting unit that transmits a request for assigning computer resources for processing data and identification information that identifies data processing to be performed on the data;
an obtaining unit that obtains storage location information showing a storage location of the data in at least part of computer resources included in one of one or a plurality of computers, the computer resources being assigned in response to the request transmitted by the assignment request transmitting unit;
a transfer unit that transfers the data to be processed by the assigned computer resources to the storage location shown by the storage location information obtained by the obtaining unit; and
a unit that causes, after the data to be processed has been transferred by the transfer unit, one or a plurality of programs constituting the data processing identified by the identification information transmitted by the assignment request transmitting unit to be deployed to the assigned computer resources so that the one or the plurality of programs are executed using the assigned computer resources.

4. An information processing method comprising:
receiving a request for assigning computer resources for processing data and identification information that identifies data processing to be performed on the data;
assigning at least part of computer resources included in one of one or a plurality of computers in response to the received request;
specifying storage location information showing a storage location of the data in the assigned computer resources on the basis of the assigned computer resources;
transferring the data to be processed by the assigned computer resources to the storage location shown by the specified storage location information; and
deploying, after the data to be processed has been transferred to the storage location, one or a plurality of programs constituting the data processing identified by the received identification information to the assigned computer resources so that the one or the plurality of programs are executed using the assigned computer resources.

5. A computer readable medium storing a program causing a computer to execute a process, the process comprising:
receiving a request for assigning computer resources for processing data and identification information that identifies data processing to be performed on the data;
assigning at least part of computer resources included in one of one or a plurality of computers in response to the received request;
specifying storage location information showing a storage location of the data in the assigned computer resources on the basis of the assigned computer resources;
causing the data to be processed by the assigned computer resources to be transferred to the storage location shown by the specified storage location information; and
deploying, after the data to be processed has been transferred to the storage location, one or a plurality of programs constituting the data processing identified by the received identification information to the assigned computer resources so that the one or the plurality of programs are executed using the assigned computer resources.

6. A computer readable medium storing a program causing a computer to execute a process, the process comprising:
transmitting a request for assigning computer resources for processing data and identification information that identifies data processing to be performed on the data;
obtaining storage location information showing a storage location of the data in at least part of computer resources included in one of one or a plurality of computers, the computer resources being assigned in response to the request;
transferring the data to be processed by the assigned computer resources to the storage location shown by the obtained storage location information; and
causing, after the data to be processed has been transferred, one or a plurality of programs constituting the data processing identified by the transmitted identification information to be deployed to the assigned computer resources so that the one or the plurality of programs are executed using the assigned computer resources.
